(19) United States
(12) Patent Application Publication
(10) Pub. No.: US 2007/0052545 A1
(43) Pub. Date: Mar. 8, 2007

(54) Onboard motor vehicle control system

(75) Inventor: Lan Le Gallic, Montfermeil (FR)

Correspondence Address: Valeo Climate Control Corp.;Intellectual Property Dept., 4100 North Atlantic Boulevard, Auburn Hills, MI, 48326, US

(73) Assignee: Valeo Systemes Thermiques S.A.S., Le Mesnil Saint Denis (FR)

(21) Appl. No.: 11/504,020

(22) Filed: Aug. 14, 2006

(30) Foreign Application Priority Data
Sep. 2, 2005 (FR) 05 09029

(51) Int. Cl. G08B 5/00

(52) U.S. Cl. 340/815.4

(57) ABSTRACT

Onboard control system (1), particularly for motor vehicles, comprising a control device (9), buttons (13, 15), and a computer (5) capable of responding to the actuation of the buttons (13, 15) by executing the onboard device (3) control functions selectively, characterised in that the computer (5) is capable of controlling a display device (11) with a view to displaying the buttons (13, 15) and responding to the actuation of at least a first button (13) by reassigning onboard device (3) control functions to second buttons (15) while refreshing the display of the second buttons (15) to indicate the function associated therewith.

The invention relates to an onboard control system, particularly for a motor vehicle.

It is observed that numerous onboard devices are provided in vehicles. These devices, practically as standard, incorporate a compact disk player combined with a car radio and an air conditioning installation. Devices such as a GPS (global positioning system) navigation assistance device are still less common but are becoming increasingly common. These devices are provided in addition to the well-known devices, which have been fitted in vehicles for a long time, such as ventilation or heating.

As such, the usefulness of a control system for controlling the various onboard devices is understood.

The European patent applications published under numbers EP 0 701 926 A2 and EP 0 366 132 A2 for example describe control systems.

EP 0 366 132 A2 thus describes a control device wherein a single switch is provided to select the groups of functions relating to the onboard devices, then to select a specific function in the selected group. The switch is provided for turning with axial movement.

This device results in risks of error in function selection, particularly when the number of functions is high. In addition, a function is finally selected after a large number of switch operations. This requires considerable attention from the driver. Consequently, this distracts the driver, possibly for a long time. It is understood that this impairs safety.

EP 0 701 926 A2 describes a multifunction control device wherein a control surface is associated with a screen and is used to control functions such as air conditioning, navigation assistance, audio devices and a mobile telephone. The device described comprises a control surface and a screen integrated in the same product. Firstly, this has an adverse effect on the integration of the device in a car interior. Secondly, the driver needs to divert his/her eyes from the road and probably turn his/her head to read the screen. This impairs safety.

As such, the purpose of the invention is to improve the situation by proposing a new kind of control system that is easy to operate while enabling access to a large number of functions.

The invention relates to an onboard control system, particularly for motor vehicles, comprising a control device, buttons, and a computer capable of responding to the actuation of the buttons by executing the onboard device control functions selectively.

The invention stipulates that the computer is capable of controlling a display device with a view to displaying the buttons and responding to the actuation of at least a first button by reassigning the onboard device control functions to second buttons while refreshing the display of the second buttons to indicate the function associated therewith.

In this way, a link is created between the display of the buttons and their discriminating geometric configuration that enables the driver to actuate the buttons without looking at them. In addition, the display device may be positioned in the driver's view, for example above the steering wheel, while the control device may be positioned within reach, for example just next to the steering wheel. It is understood that in this configuration the driver can operate the control system while still concentrating on the road. The selection of a specific function remains simple if a large number of functions are provided.

In one advantageous embodiment, the second buttons at least are arranged according to a discriminating geometric configuration.

In one specific embodiment, the second buttons comprise a turning control device, wherein the position is displayed on the display device.

The computer is then preferentially capable of responding to a change in position of the turning control device by changing the value of a parameter associated with the onboard device control function assigned to the turning control device while refreshing the display of the turning control device to indicate the value of said parameter.

In another specific embodiment of the invention, the control device comprises at least one pair of first buttons and a series of second buttons arranged in the vicinity of said pair.

The control device may comprise two separate pairs arranged in the vicinity of a first series of second buttons and a second series of second buttons.

Preferentially, the first button controls a function relating to at least one device from an air conditioning device, a communication device, an audio broadcasting device, a navigation assistance device and a vehicle positioning device.

In all the embodiments, the control device advantageously comprises detection means capable of detecting the presence of a finger in the vicinity of a button, and the computer is capable of responding to such detection by changing the display of the button on the display device.

The detection may be of the capacitive-type.

The change of the display preferentially involves highlighting of the button.

The change of the display then advantageously involves highlighting of the function assigned to the button.

In one specific embodiment, the computer comprises at least one interface to obtain operating data from an onboard device and the computer is capable of responding to a change in the operating data by reassigning additional onboard device control functions to the second buttons, and refreshing the display of the second buttons to indicate the additional function assigned thereto.

In one particularly advantageous embodiment, the computer responds to the actuation of the first button by reassigning functions relating to the same specific onboard device to the second buttons.

In all the embodiments, at least one of the buttons may be of the push button-type.

In a first alternative embodiment, the computer is capable of responding to the actuation of a first button by assigning to the second buttons a function relating to an air conditioning device with respectively different device operating parameters.

In a second replacement or additional alternative embodiment, the computer is capable of responding to the actuation of a first button by assigning to the second buttons a function controlling playback of different optical disks respectively.

In a third replacement or additional alternative embodiment, the computer is capable of responding to the actuation of a first button by assigning to the second buttons a function controlling the positioning of a radio tuner on pre-recorded stations.

In a fourth replacement or additional alternative embodiment, the computer is capable of responding to the actuation of a first button by assigning to the second buttons functions such as an address book, last destination, new destination and geographic map-type function.

In a fifth replacement or additional alternative embodiment, the computer is capable of responding to the actuation of a first button by assigning to the second buttons functions such as an address book, last telephone number dialed, telephone number dialing and message access-type function.

In all the embodiments, the first button is advantageously associated with a specific function while the second buttons are associated with sub-functions of said specific function.

Other characteristics and advantages of the invention will emerge on examining the detailed description hereinafter and the appended figures wherein:

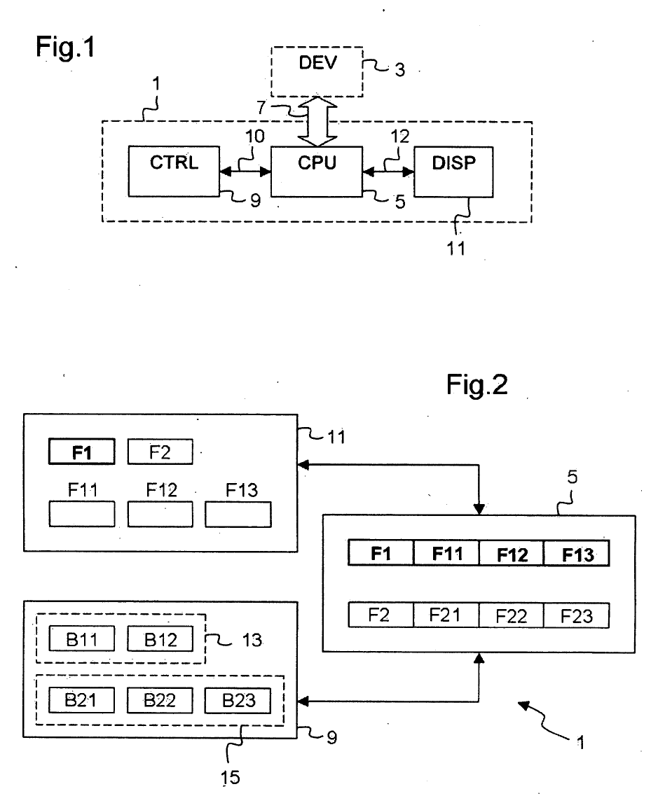

FIG. 1 is a functional diagram of a control system according to the invention,

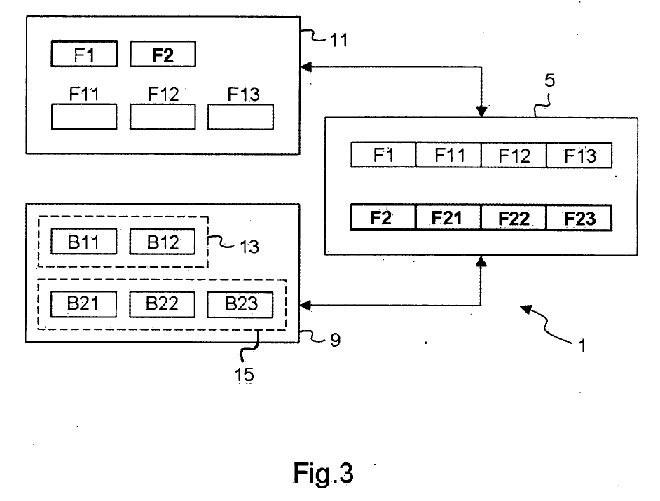

FIGS. 2 and 3 are diagrams of the control system in FIG. 1 in different operating states,

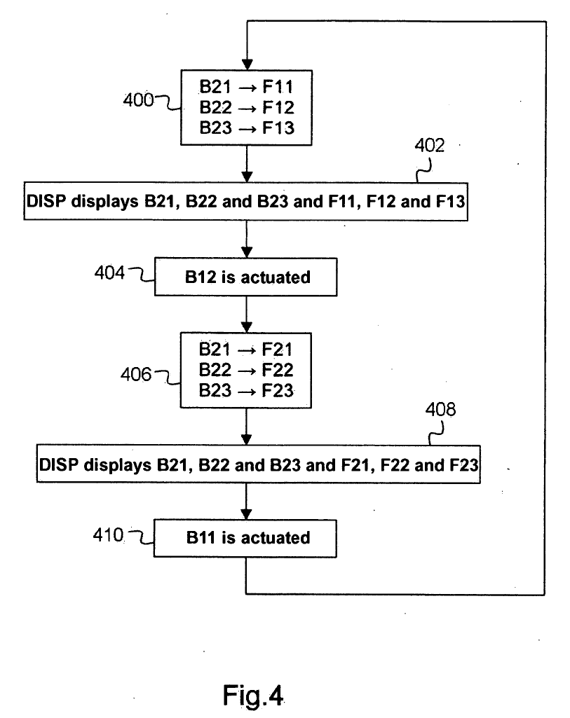

FIG. 4 is a flow chart illustrating the operation of the control system in FIG. 1,

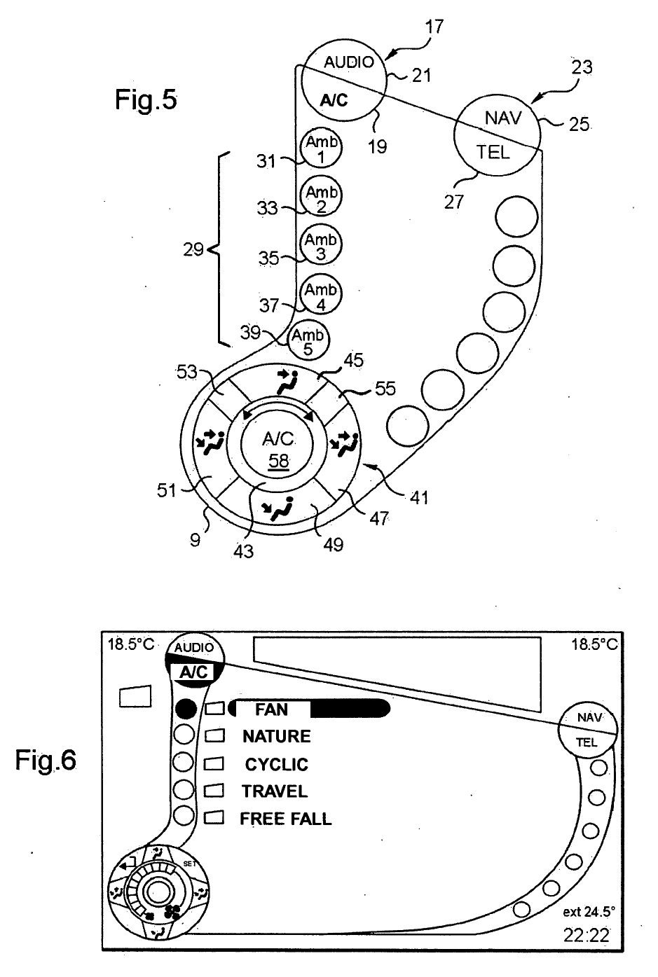

FIG. 5 functionally shows a control device for the control system in FIG. 1,

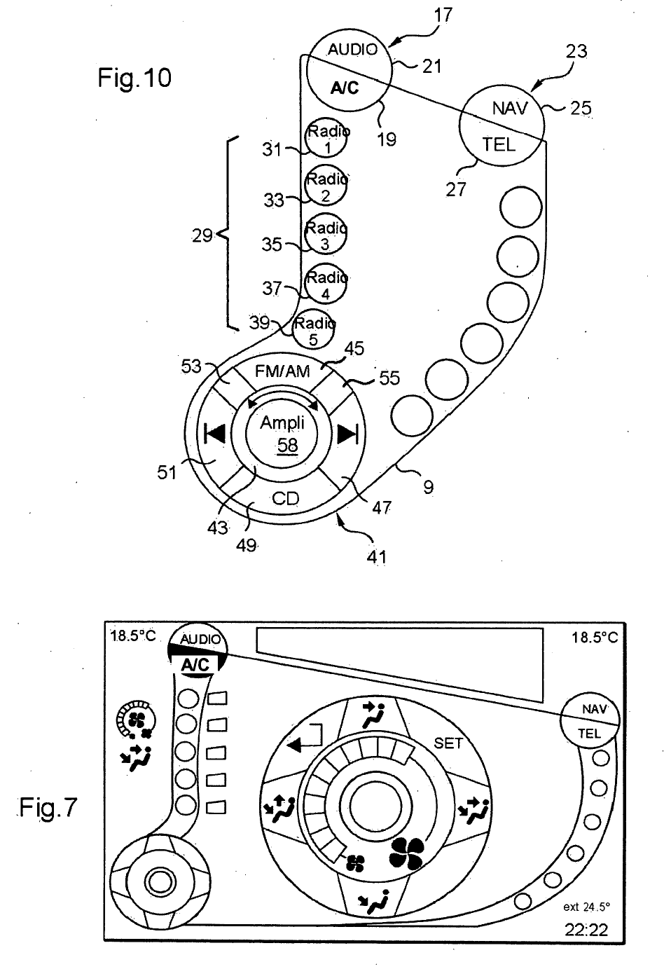

FIGS. 6 and 7 show the display of a display device for the control system in FIG. 1 in a first operating state,

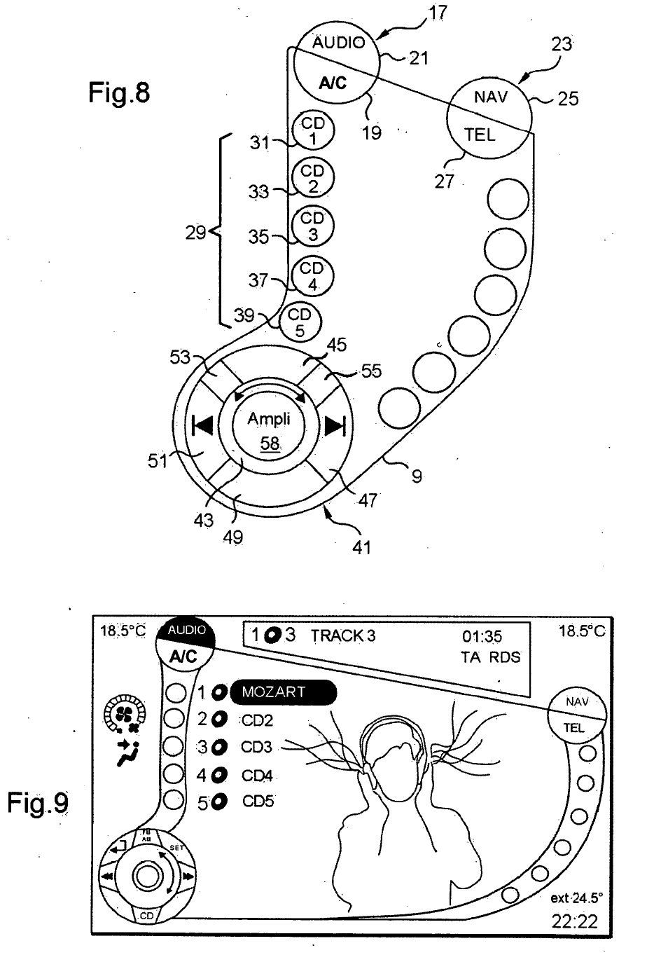

FIG. 8 shows a control device similar to that in FIG. 5 in a different operating state,

FIG. 9 shows the display of the display part for the control system in the operating state in FIG. 8,

FIG. 10 shows a control device similar to FIG. 5 in another operating state,

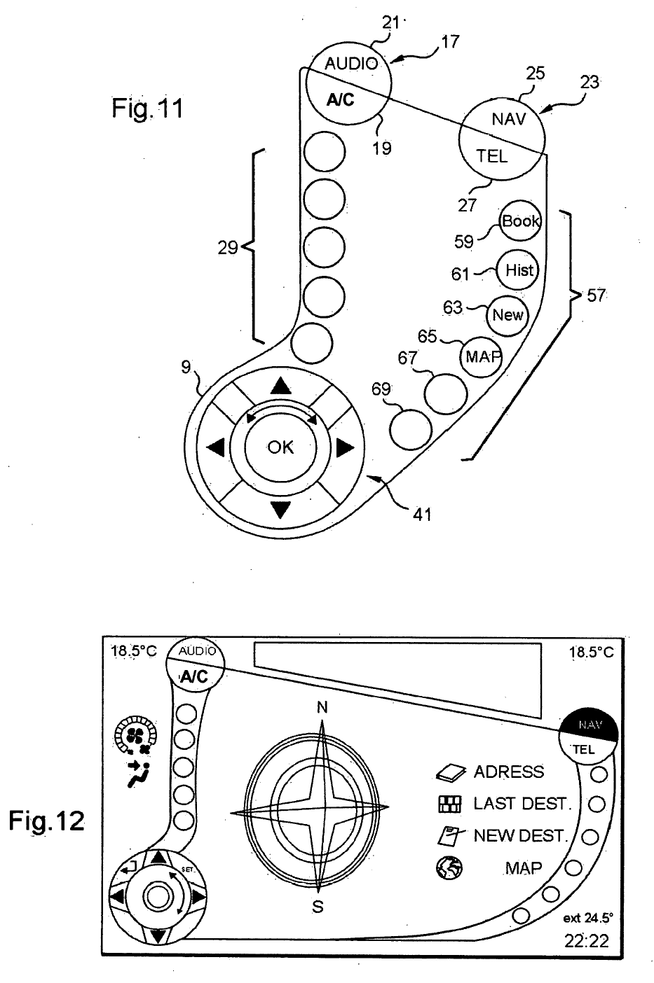

FIGS. 11 and 12 respectively show a control device and the display of a display device, the control system being in another operating state,

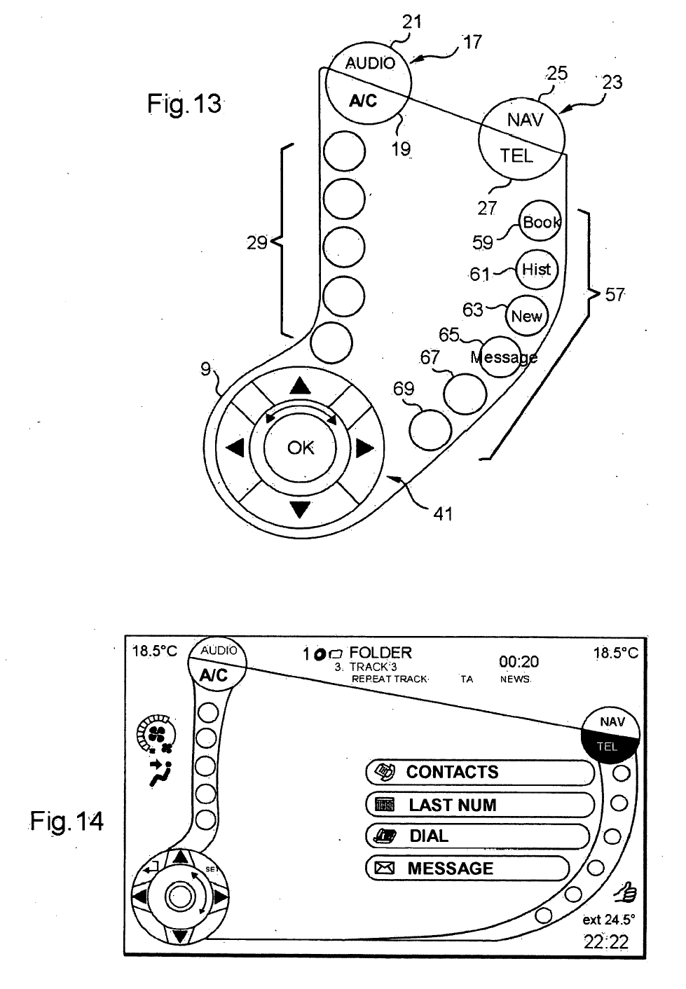

FIGS. 13 and 14 respectively show a control device and the display of a display device, the control system being in another operating state,

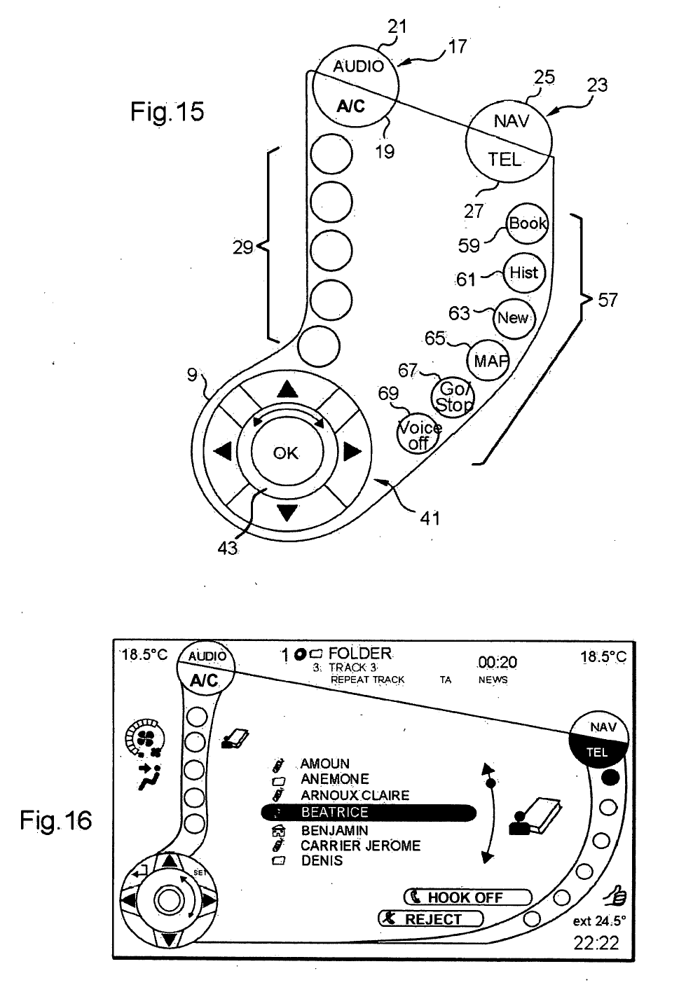

FIGS. 15 and 16 respectively show a control device and the display of a display device, the onboard control system being in the same operating state as in FIGS. 13 and 14,

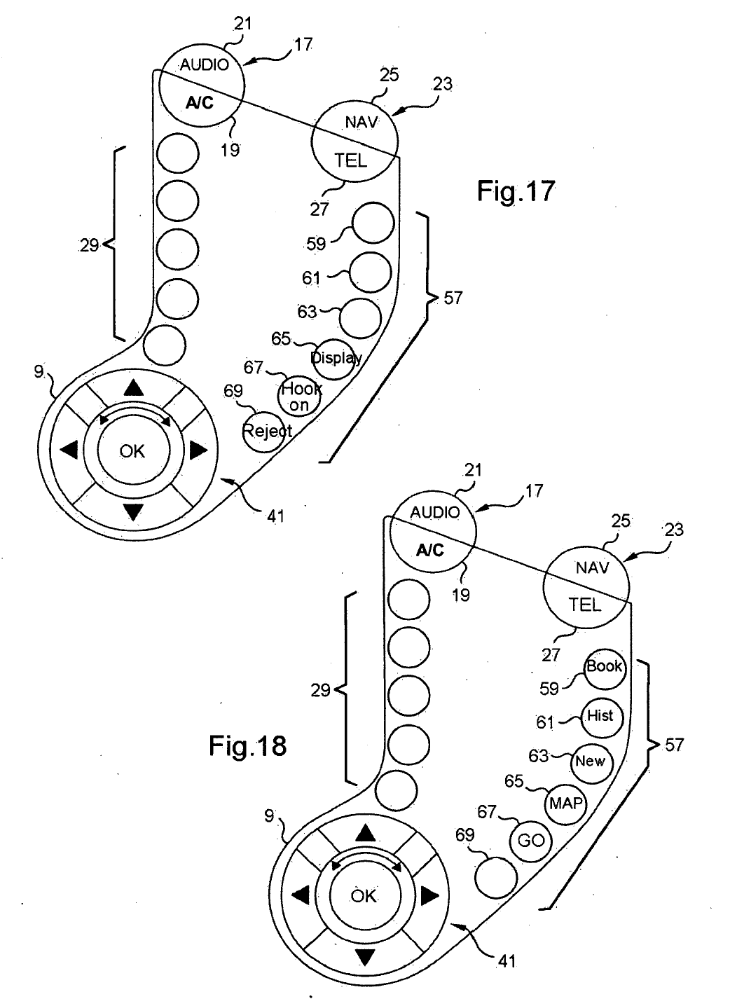

FIG. 17 shows a control device, the onboard control system being in the same operating state as in FIG. 15,

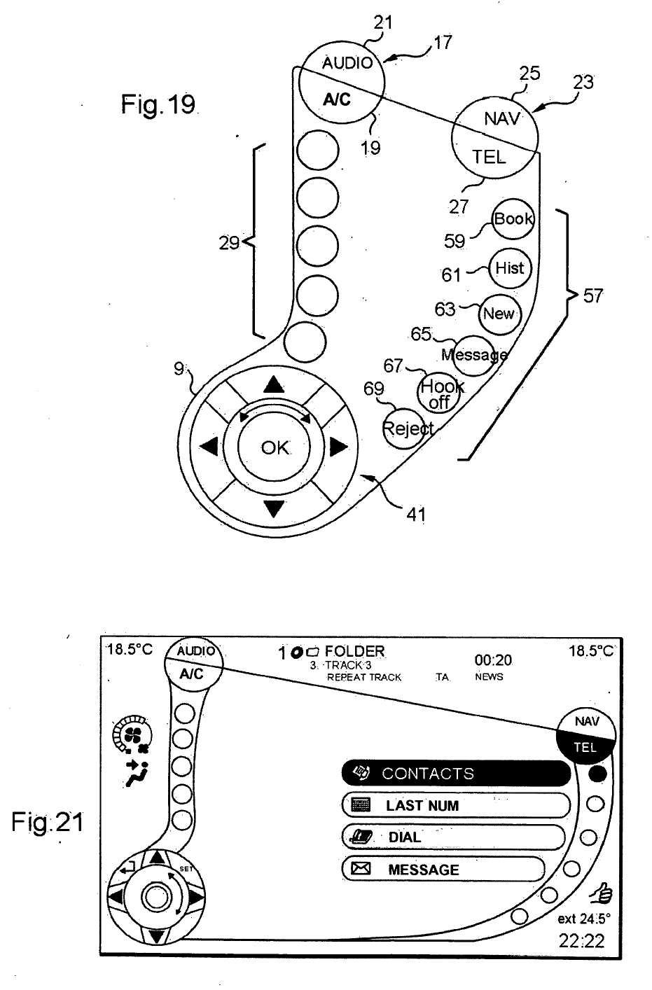

FIGS. 18 and 19 show a control device, the onboard control system being in the same operating state as in FIG. 11,

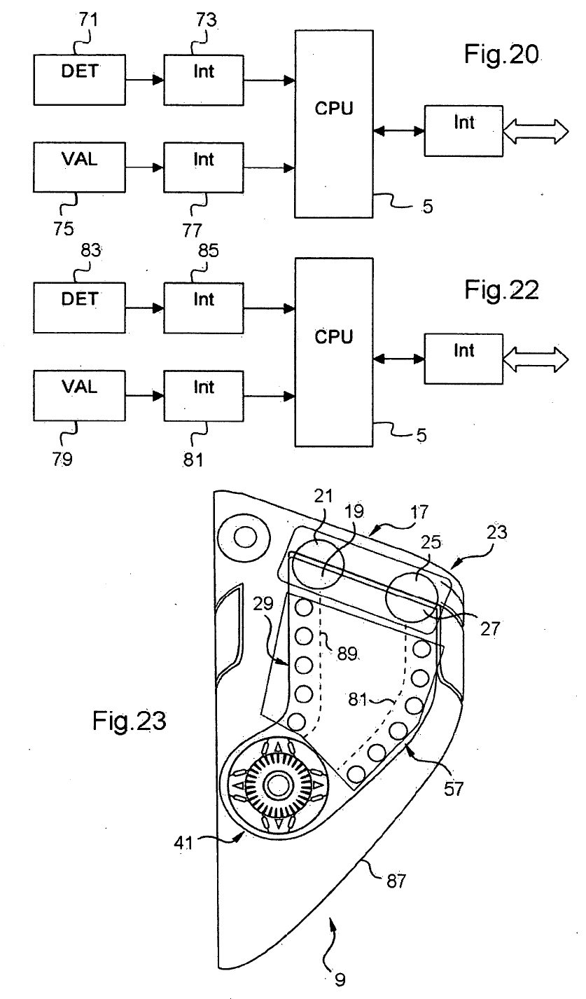

FIG. 20 is a functional diagram of a specific embodiment of a button for a control device according to the invention,

FIG. 21 shows the display of a display device cooperating with a button according to the embodiment in FIG. 20,

FIG. 22 shows the display of a display device cooperating with a button according to the embodiment in FIG. 20 in another button embodiment,

FIG. 23 is a perspective view of a control device in one specific embodiment,

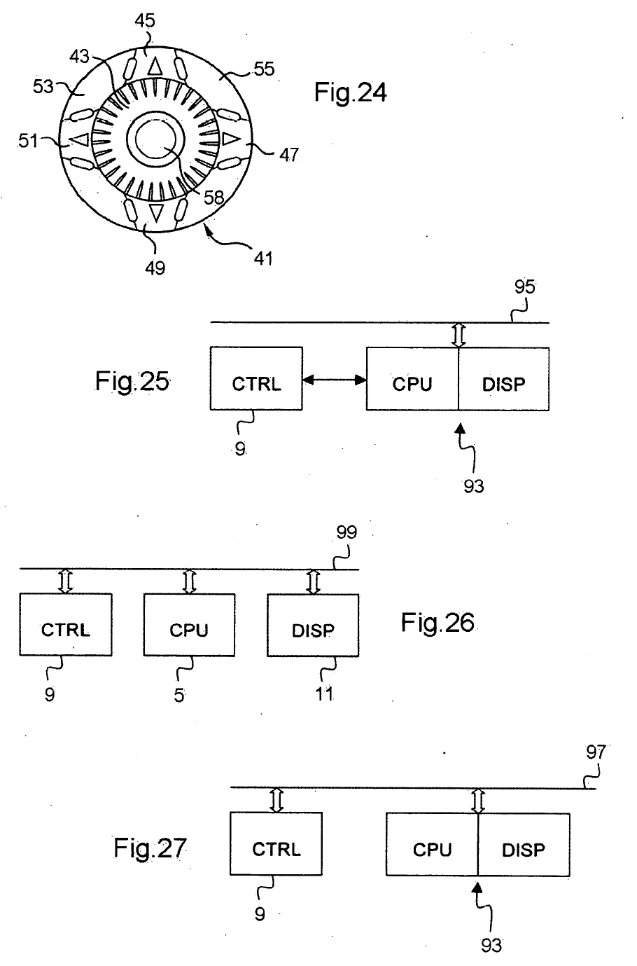

FIG. 24 shows in detail a button of a control device in the embodiment in FIG. 23, and

FIGS. 25 to 26 show the alternative embodiments of the control system according to the invention.

The appended figures may be used not only to complement the invention, but also to contribute to its definition, where applicable.

FIG. 1 shows an onboard control system 1, for example for a motor vehicle.

The function of the control system 1 is to control onboard devices (DEV) 3. In particular, the control system 1 is used to control devices 3 by a user, particularly the driver of a motor vehicle, by interacting therewith.

The term “onboard devices” refers in this case to any onboard device in the vehicle capable of interacting, for any reason, with a user. A heating, ventilation and/or air conditioning device, a communication device, for example a mobile telephone, an audio broadcasting device, such as a car radio, compact disk player for example, or a navigation assistance and/or positioning device such as a GPS device are examples of onboard devices 3 capable of being controlled by the control system 1. In this way, the devices 3 in FIG. 1 may comprise one or more of the abovementioned devices, taken separately or in combination.

The control system 1 comprises a computer 5 (CPU) capable of executing control instructions for the devices 3. These instructions may be organised into functions. For example, this consists of an ordered sequence of instructions. The term function in this case must be understood in the broadest sense of the term: this term does not necessarily refer to a data processing or mathematical function.

The computer 5 may comprise a microcontroller, for example of the 8 bit-, 16 bit-, 32 bit- or 64 bit-type. Other computer models may be used.

The computer 5 is connected to the different devices 3 via a signal exchange connection 7. The connection 7 is in this case of the BUS-type, and more specifically the high-speed CAN BUS-type.

The control system 1 also comprises a control device 9 (CTRL) that can be used by a user. In particular, the control device 9 comprises buttons that can be actuated by the user.

The control device 9 is connected to the computer 5 via a signal exchange connection 10. For example, the connection 10 may be of the BUS-type, more specifically the local bus-type and even more specifically the Lin/Can-type.

The signals received from the control device 9 form inputs of the computer 5. In this way, the computer 5 is capable of responding to the actuation of the buttons by selectively executing control functions relating to the devices 3. Because it enables the control of the devices 3 by a user, the computer 5 is sometimes referred to as a man-machine interface computer. It is understood that, for the same reason, the control system 1 may be referred to as man-machine interface system.

Preferentially, the control device 9 is arranged so as to be integrated easily in the vehicle interior, for example on the board panel. The control device 9 is advantageously configured so as to be able to be arranged in the vicinity of the control station, for example in the vicinity of the steering wheel or gear lever. In this way, the driver can actuate the buttons of the control device 9 while driving.

The control system 1 also comprises a display device 11 (DISP) connected to the computer 5 via a signal exchange connection 12. The display device 11 may comprise a liquid crystal screen (colour or monochrome). An information display device on the windscreen could also be used as a display device 11. Such devices are referred to as “Head-Up” displays or screens. Preferentially, the display device 11 is arranged so as to be able to be integrated in the car interior, advantageously in the immediate visual vicinity of the driver so that he/she does not need to divert his/her eyes from the road.

Tricolour red, green and blue digital or composite video-type connections are examples of connections 12 that may be used between the computer 5 and the display device 11. It is understood that the choice of the type of connection may depend at least partially on the type of display device 11 used.

The computer 5 is capable of controlling the display device 11 by activating the display of information on said device. Because it also handles the display of the display device 11, the computer 5 may also in this case be referred to as a “logical and graphic computer”.

The connection 12 is generally one-way. However, this connection 12 may in some cases be two-way, for example if the display device 11 comprises a touch-type screen connected as an input to the computer 5.

FIG. 2 shows schematically and functionally the control system 1 in FIG. 1, in a simplified example of an embodiment.

In this case, the control device 9 physically comprises the first buttons B11 and B12 referred to in their entirety by the numeric reference 13 and the second buttons B21, B22 and B23 referred to in their entirety by the numeric reference 15. The second buttons 15 are arranged according to a discriminating geometric configuration, in particular with reference to the first buttons 13. This means that a user of the control device 9 can easily distinguish between the first buttons and the second buttons 15 particularly by means of their relative position. This distinction may be visual and/or tactile. Preferentially, the shape of the first buttons 13 and the second buttons 15 may be essentially different to increase the distinction.

The second buttons 15 are respectively associated with functions F11, F12 and F13 that can be executed selectively by the computer 5. In other words, the computer 5 is capable of responding to the actuation of one of the second buttons 15, for example the button B22, by executing one of the functions F11, F12 and F13, for example the function F12. This operating state of the control system 1 is shown by the step 400 in FIG. 4, which shows the operation of the computer 5 in this simplified embodiment example.

The computer 5 is also capable of controlling the display device 11 so as to display a display of the second buttons 15 according to their discriminating geometric configuration on the control device 9. In addition, the computer 5 activates the display of an identifier (in this case, F11, F12 and/or F13) of the function associated with each of the second buttons 15. This corresponds to step 402 in FIG. 4. In this case, the shape of the second buttons 15 has been reproduced for the display of the buttons on the display device 11. It is understood that the shape of the second buttons 15 displayed on the display device 11 may be substantially different from the shape of the second buttons 15. In particular, it may be simplified or schematized.

The computer 5 controls the display device 11 so as to generate a display of the first buttons B11 and B12 according to their geometric configuration. The computer 5 also controls the display of an identifier F1 of a function F1 associated with the button B11 and an identifier F2 of a function F2 associated with the button B12. As above, “associate” means that the computer 5 is capable of responding to the actuation of the button B11 (respectively B12) by executing the function F1 (respectively F2). Here again, the display of the buttons B11 and B12 reproduces the geometric shape thereof.

The computer 5 is arranged so as to respond to the actuation (step 404) of the button B12 by reassigning the functions associated with the first buttons 15. This may be seen as the execution of at least part of the function F2 associated with the button B12.

In particular, the computer 5 assigns a function F21 to the button B21, a function F22 to the button B22 and a function F23 to the button B23 as indicated by the step 406 of the flow chart in FIG. 4.

The computer 5 is also configured so as to respond to the actuation of the button B12 by refreshing the display of the display device 11 so as to display the identifiers of the functions F21, F22 and F23 newly assigned to the buttons B21, B22 and B23 (step 408). This can be seen in FIG. 3.

FIGS. 2 and 3 show that the computer 5 is capable of controlling the display device 9 so as to obtain a display of the first button actuated and the highlighted associated function. In these figures, the first button actuated (B11 in FIG. 2 and B12 in FIG. 3) has been shown in bold font. In practice, the highlighting of the display of the buttons may be carried out by highlighting (increase in contrast), a change of colour, magnification or any other graphic effect.

It is understood that the computer 5 is arranged so as to respond to the actuation of the button B11 in step 410 in FIG. 4 by reassigning the functions F11, F12 and F13 to the buttons B21, B22 and B23 respectively and by controlling the refreshing of the display of the display device 11. In other words, the actuation of the button B11 visually activates the change of the display of the display device 11 in FIG. 3 to that in FIG. 2.

The control system 1 shown in FIGS. 2 and 3, although simplified, offers easy control for a set of functions by a hierarchical organisation of these functions. Consequently, even if a large number of these functions are provided, the user can control them easily using the control device 9. The operation of this control device 9 linked with the display device 11 renders the use of the control system 1 simple and intuitive, enabling inexperienced users to understand and use the system quickly.

With the geometric discrimination of the second buttons 15 and, preferentially also of the first buttons 13, and the display thereof on the display device 11, the user does not need to look at both the control device 9 and the display device 11. More precisely, the user does not need to look at the control device 9 to actuate buttons. Consequently, the display device 11 may be offset from the control device 9. This particularly results in easier integration of the control system 1 in the car interior and greater safety during the operation thereof.

In some embodiments, the display of the second buttons as such on the display device 11 could be omitted and replaced only by the indications of identifiers of functions associated with the buttons in a geometric configuration corresponding to the geometric configuration of these buttons on the control device 9.

FIG. 5 shows a practical embodiment of the control system 1 according to the invention. The control device 9 shown in this FIG. 5 comprises a first pair 17 of first buttons 19 and 21 and a second pair 23 of first buttons 25 and 27.

The control device 9 comprises a first series 29 of second buttons 31, 33, 35, 37 and 39 arranged in a curve. The first series 29 is arranged in a discriminating geometric configuration with reference to the first buttons 19 and 21 while being arranged in the vicinity thereof.

As shown functionally in FIG. 5, the first button 19 is associated with an “A/C” function relating to the control of a heating, ventilation and/or air conditioning device (HVAC) (or set of devices). In this case, the HVAC device is understood in the broad sense of the term and may thus comprise a fan, heater, air conditioning unit, etc. Consequently, the functions associated with the buttons of the series 29 are also functions relating to the control of an HVAC device. As above, a function is said to be “associated with a button” when the computer 5 is arranged to respond to the actuation of said button by executing said function.

For example, the button 31 is associated with a function “Amb1”. Similarly, the buttons 33, 35, 37 and 39 are respectively associated with functions “Amb2”, “Amb3”, “Amb4” and “Amb5”. These functions may each associate different operating parameter values of the air conditioning unit, in particular, these values may be pre-defined. For example, these parameters may comprise a fan rotation speed, a blown air temperature in the car interior, a recycled air circulation or open to the outside, etc. In this case, the acronym “Amb” defines a specific ambient atmosphere associated with a respective button.

FIG. 6 shows the display of the buttons 19 and 21, the series 29 and identifiers of the functions associated with the different buttons displayed on the display device 11 and controlled by the computer 5. It comprises a display of the button 19 and an “A/C” identifier of the air conditioning function highlighted by a graphic lighting effect. Other means for highlighting the button 19 may also be used.

The computer 5 is arranged to control a display of the buttons of the series 29 such as the buttons 31, 33, 35, 37 and 39 are displayed substantially according to their geometric arrangement on the control device 9. The identifiers of the functions associated with these buttons (“FAN”, “NATURE”, CYCLIC”, “TRAVEL” and “FREE FALL”, respectively) are selected so as to be easily intelligible for the user.

In this embodiment, the computer 5 is also arranged so as to control a display of the buttons 21, 25 and 27 on the display device 9 according to the spatial arrangement thereof on the display device 9. This display also comprises identifiers of functions associated with the buttons 21, 25 and 27, i.e. “AUDIO”, “NAV” and “TEL” respectively.

In this embodiment, the control device 9 also comprises a set of additional second buttons 41. It particularly comprises a turning control device 43 and additional second buttons 45, 47, 49, 51, 53, 55 and 58.

As demonstrated in FIG. 5, the additional second buttons 45, 47, 49 and 51 are for example also distributed around the turning control device 43. The additional second buttons 53 and 55 are for example arranged on either side of the button 45 while a central additional second button 58 is arranged substantially at the centre of the set of second buttons 41.

These additional second buttons 41 are arranged in a distinctive spatial configuration in the direction described above. In particular, all of the buttons 41 have a round appearance while the second buttons of series 29 have a long appearance. In addition, the set 41 is arranged in the vicinity of one end of the series 29, in this case, at the end opposite the end near the first pair 17.

The computer 5 controls the display device 11 so as to display the set 41 and the buttons comprised therein, in accordance with their distinctive geometric configuration and their appearance.

The controller 5 is capable of responding to the actuation of the turning control device 43 by associating with a specific function the value of a parameter of this function. In this embodiment, the computer 5 is arranged so as to associate a value of a parameter associated with a rotation speed of a fan in the position of the turning control device 43. As shown in FIG. 7, the computer 5 controls the display device 11 so as to represent different positions of the turning control device 43.

In FIG. 8, the first button 21 associated with an “AUDIO” function is actuated so that the computer 5 responds by reassigning to the series 29 functions relating to one or more audio-type devices.

In this embodiment, the audio-type devices comprise a compact disk player. The computer 5 is capable of responding to the actuation of the button 31 by executing a “CD1” function controlling the loading of a first compact disk of a disk loader in the compact disk player.

FIG. 9 shows the display of the corresponding display device 11. The display of the button 31 on said device is associated with the identifier “MOZART” corresponding to the “CD1” function. In this case, the function identifier takes the form of information relating to the first disk, particularly the name of the composer of the recorded works.

The computer 5 is capable of associating with each position of the device 43 a value of a parameter associated with the volume of an amplification device.

The computer 5 is capable of responding to the actuation of the button 21 by also reassigning functions to the set 41 of additional second buttons. For example, an “FM/AM” function is associated with the additional second button 45. The computer 5 is arranged so as to respond to the actuation of this button 45 by reassigning functions to the series of buttons 29, as indicated in FIG. 10. In this figure, each button of the series 29 is associated with a function activating the position of a radio tuner on a preset radio station frequency. For example a “RADIO1” function is associated with the button 31. Although it is not shown here, it will be understood that the display of the display device 11 is modified by the computer 5 so as to display a radio station identifier in the vicinity of the display of the button 31.

Reference will now be made again to FIG. 8. A function activating the playback of a track following (respectively preceding) the current track is associated with the button 47, respectively 51. A visual function identifier may comprise a pictogram instead of a sequence of alphanumeric characters. The computer 5 is arranged to respond to the actuation of the button 49 by switching the radio receiver source to the compact disk player source. If there are several compact disk player-type devices (for example a player and a loader), the computer 5 may be arranged to respond to successive pressing of the button 49 by switching the audio source between the radio receiver and the various compact disk devices.

As shown in FIG. 11, the control device 9 comprises a second series 57 of buttons 59, 61, 63, 65, 67 and 69. The first button 25 is associated with a “NAV” function. The computer 5 is arranged so as to respond to the actuation of the button 25 by assigning to the buttons of the second series 57 functions relating to the control of a navigation assistance device, for example of the GPS-type. In particular, the actuation of the button 25 assigns by the computer 5 a “BOOK” function to the button 59, a “HIST” function with the button 61, a “NEW” function with the button 63 and a “MAP” function with the button 65. It should be noted that the computer 5 does not assign a function to the buttons 67 and 69.

The computer 5 controls the display device 11 so as to produce a display of the buttons of the series 57 and identifiers of the associated functions as shown in FIG. 12. The button 59 is visually associated with the identifier “ADDRESS”, the button 61 with “LAST DEST.”, the button 63 with “NEW DEST” and the button 65 with “MAP”. The buttons 67 and 69 are displayed on the display device 11 but no function identifier is visually associated with these buttons.

The “BOOK” function determines the management of a destination address book stored in a memory provided in the vehicle. The “HIST” function gives access to the last destinations entered in the navigation assistance device. The “NEW” function determines the input of a new destination to search a new route. The “MAP” function determines the display of a road map, for example on the same display device 11. Again, it is noted that the visual identifiers are selected so as to be easily intelligible for the user.

In FIGS. 13 and 14, the button 27 associated with a “TEL” function relating to a mobile telephone device is activated. A “BOOK” function for viewing an address of contacts visually identified as “CONTACTS” is associated with the button 59. A “HIST” function activating the display of the last number dialed visually identified as “LAST NUM.” is associated with the button 61. A “NEW” function controlling the dialing of a new telephone number visually identified as “DIAL” is associated with the button 63. Finally, a “MESSAGE” function gives access to incoming messages visually identified as “MESSAGES” is associated with the button 65.

The computer 5 is arranged so as to respond to the actuation of the button 59 by assigning to a position regulator 43 a navigation function in a list of contacts as shown in FIGS. 15 and 16.

In addition, the computer 5 is capable of interacting with mobile telephone device call detection means and responding to the detection of an incoming call by assigning the “HOOK OFF” and “REJECT” functions to the buttons 67 and 69 while controlling the refreshing of the display of the display device 11 so as to display these two new functions (visually identified as “HOOK OFF” and “REJECT”) newly associated with the displays of the buttons 67 and 69.

The “HOOK OFF” function controls the unhooking of the mobile telephone device while the “REJECT” controls call rejection.

The computer 5 is capable of responding to the actuation of the button 67 (acceptance of detected call) by assigning a “DISPLAY” function to the button 65, a “HOOK ON” function to the button 67 and the same “REJECT” function as above to the button 69, as indicated in FIG. 17. The “DISPLAY” function switches the display between the different types of information specific to the telephone device, for example the duration of a call, the time of a call, the number called, etc. The “HOOK ON” function controls the hanging up of the mobile telephone device.

The functions assigned to the different buttons may be determined by the detection of an operating context. In FIGS. 18 and 19 for example, the functions assigned to the buttons 67 and 69 by the computer 5 depend on an operating state of the navigation assistance device. In FIG. 18, the button 67 is associated with a “GO” function starting an actual positioning system to a selected destination. The computer 5 is arranged so as to respond to the actuation of the button 67 by associating a “GO/STOP” function and the button 69 associating a “VOICE OFF” function. The “GO/STOP” function controls the resumption and interruption of the positioning system in alternation. The “VOICE OFF” function controls the deactivation of a possible audio aid for the positioning system.

In a particularly advantageous embodiment of the invention shown in FIG. 20, the control system 1 also comprises presence detection means 71 (DET) capable of detecting the presence of a finger in the vicinity of one of the buttons of the control device 9. The presence detection means 71 are connected to the computer 5 via an interface 73. The computer 5 is arranged so as to respond to the detection of a finger in the immediate vicinity of a button by controlling the display device 11 so as to highlight the display of said button, and, if applicable, of the associated function identifier. For example, FIG. 21 shows the consequence of the detection of a finger on the button 59 when the button 27 is actuated. In this way, a change in the colour of a zone of the display surrounding the function identifier and a lighting effect on the display of the button 59 are noted.

The control system 1 also comprises validation means 75 connected to the computer 5 via an interface 77. The computer 5 is arranged so as to respond to the detection of a validation by executing the function associated with the button on which a finger was previously detected.

The validation can be controlled by pressing a button key or by pressing a sensitive zone according to the embodiment of said button.

In a particularly advantageous embodiment, the detection means 71 and the validation means 77 respectively comprise detection devices and validation devices specific to each button.

The detection device may be of the capacitive-type. For example, it is possible to provide a metal surface wherein the capacitance is measured by suitable means in the vicinity of the zone of the operated button. The capacitance measurement means are capable of detecting a variation in capacitance due to the presence of a finger. This metal surface may be arranged under a mobile key in translation actuating, at the limit, a switch to form a button with validation and detection functions in the form of a push button.

Similarly, as indicated in FIG. 22, the control system 1 may also comprise function setting means 79 connected to the computer 5 via an interface 81 and linked with finger presence detection means 83 connected to the computer 5 via an interface 85. The computer 5 is arranged so as to respond to a detection of a change of position on the turning control device on which a finger was previously detected by varying the value of a parameter associated with the device.

In a particularly advantageous embodiment, the detection means 83 and the validation means 79 respectively comprise detection devices and validation devices specific for each device.

The turning control device 43 may comprise a turning part that can be operated by the user and linked with a metal surface wherein the capacitance is measured by suitable means. These means are capable of responding to a variation in the capacitance of the metal surface activated by the presence of a finger in the vicinity of the turning part.

FIGS. 23 and 24 show an embodiment of the control device 9 in FIG. 5 in particular. The control device 9 is embodied in the form of a housing 87, for example made of plastic, whereon the buttons described above are found. The general appearance of the housing 87 corresponds to the general arrangement of the buttons so as to show a relatively small total surface area (restricted as much as possible to the buttons). This makes it possible firstly to reduce the size of the housing 87 and therefore facilitate the integration thereof. In addition, the reduction of the surface of the housing 87 prevents the user's fingers from straying on said surface. The reduction of the surface assists the user in locating the various buttons by touch. To facilitate the guidance of the fingers on the buttons, in particular on the series of buttons 29 and 57, two grooves 89 and 91 are provided, at the base of which the buttons are arranged. In this way, a finger can be guided along each groove 89 and 91 and can pass successively on each button in a series. As a general rule, the buttons of the control device 9 are configured so as to display a raised surface to facilitate their location by touch.

It may also be envisaged to use different roughnesses to facilitate the differentiation of the buttons and the panel.

Alternative embodiments may be envisaged on the basis of the above embodiments.

In particular, functionally different arrangements of the control system 1 may be used. For example, the connection between the devices 3 and the computer 5 may be of the MOST (“media oriented system transport”) BUS-type, providing high-speed transport on the communication bus. The computer 5 and the display device 11 may be integrated in the same component 93 as shown in FIG. 25. The component 93 may be connected to the control device 9 via a local bus 95, of the Lin/CAN-type for example, and to the devices 3 (not shown in FIG. 25) via a MOST-type bus. In another configuration, the devices 3, the component 93 and the control device 9 could be connected by means of a common bus 97, for example a MOST BUS (FIG. 27).

Another solution shown in FIG. 26 would consist of providing a logical computer 5 and a separate graphic computer integrated in the display device 11. A common bus 99 could then be provided in the display device 11, in the (logical) computer 5 and the control device 9 so that these components communicate together. In this case, said Bus could be of the MOST-type.

In addition to the representation of the buttons on the display device 11, the various buttons may comprise visual identifiers in the form of pictograms or text keys, for example intended for passengers of the vehicle who would not have access to the display device. It is also possible that they are free from such identifiers, the detection method and the display device are sufficient for the identification of the buttons. Raised surface components, such as pick holes, may be provided on the buttons to facilitate identification of the buttons by touch further.

It is noted that in all the embodiments described above, the position of the first buttons with respect to the second buttons tends to recall the hierarchical organisation of the functions associated with these buttons.

The above description of the functions associated with the buttons has been given only as an example. The assignments of functions of the buttons are specific to the desired configurations. In this way, the function associated with each button may be redefined. The information associated with the buttons is also configurable.

It will be understood that the nature of the devices 3 is not limited to the examples given above. The number of buttons may be increased or decreased.

The invention is not limited to the embodiments described above as examples but covers all the alternative embodiments that may be envisaged by those skilled in the art.

1. Onboard control system (1), particularly for motor vehicles, comprising a control device (9), buttons (13, 15), and a computer (5) capable of responding to the actuation of the buttons (13, 15) by executing the onboard device (3) control function selectively, characterised in that the computer (5) is capable of controlling a display device (11) with a view to displaying the buttons (13, 15) and responding to the actuation of at least a first button (13) by reassigning onboard device (3) control functions to second buttons (15) while refreshing the display of the second buttons (15) to indicate the function associated therewith.

2. System according to claim 1, characterised in that the second buttons (15) at least are arranged according to a discriminating geometric configuration.

3. Control system according to any of claims 1 and 2, characterised in that the second buttons (15) comprise a turning control device (43), wherein the position is displayed on the display device (11).

4. System according to claim 3, characterised in that the computer (5) is capable of responding to a change in position of the turning control device (43) by changing the value of a parameter associated with the onboard device (3) control function assigned to the turning control device (43) while refreshing the display of the turning control device (43) to indicate the value of said parameter.

5. System according to any of the above claims, characterised in that the control device (9) comprises at least one pair (17, 23) of first buttons (19, 21, 25, 27) and a series (29, 57) of second buttons arranged in the vicinity of said pair (17, 23).

6. System according to claim 7, characterised in that the control device (9) comprises two separate pairs (17, 29) arranged in the vicinity of a first series (29) of second buttons and a second series (57) of second buttons.

7. System according to any of the above claims, characterised in that the first button (19, 21, 25, 27) controls a functions relating to at least one device from an air conditioning device, a communication device, an audio broadcasting device, a navigation assistance device and a vehicle positioning device.

8. System according to any of the above claims, characterised in that the control device (9) comprises detection means (71) capable of detecting the presence of a finger in the vicinity of a button, and in that the computer (5) is capable of responding to such detection by changing the display of the button on the display device (11).

9. System according to claim 8, characterised in that the detection is of the capacitive-type.

10. System according to any of claims 8 and 9, characterised in that the change of the display comprises highlighting of the button.

11. System according to any of claims 8 to 10, characterised in that the change of the display then comprises highlighting of the function assigned to the button.

12. System according to any of the above claims, characterised in that the computer (5) comprises at least one interface to obtain operating data from an onboard device and in that the computer (5) is capable of responding to a change in the operating data by reassigning additional onboard device (3) control functions to the second buttons (15), and refreshing the display of the second buttons (15) to indicate the additional function assigned thereto.

13. System according to any of the above claims, characterised in that the computer (5) responds to the actuation of the first button (59) by reassigning functions relating to the same specific onboard device (3) to the second buttons (43).

14. System according to any of the above claims, characterised in that at least one of the buttons (19, 21, 25, 27) is of the push button-type.

15. System according to any of the above claims, characterised in that the computer (5) is capable of responding to the actuation of a first button (19) by assigning to the second buttons (31, 33, 35, 37, 39) a function relating to an air conditioning device with respectively different device operating parameters.

16. System according to any of the above claims, characterised in that the computer (5) is capable of responding to the actuation of a first button (21) by assigning to the second buttons (31, 33, 35, 37, 39) a function controlling playback of different optical disks respectively.

17. System according to any of the above claims, characterised in that the computer (5) is capable of responding to the actuation of a first button (21) by assigning to the second buttons (31, 33, 35, 37, 39) a function controlling the positioning of a radio tuner on pre-recorded stations.

18. System according to any of the above claims, characterised in that the computer (5) is capable of responding to the actuation of a first button (25) by assigning to the second buttons (59, 61, 63, 65, 67, 69) functions such as an address book, last destination, new destination and geographic map-type function.

22. System according to any of the above claims, characterised in that the computer (5) is capable of responding to the actuation of a first button (27) by assigning to the second buttons (59, 61, 63, 65, 67, 69) functions such as an address book, last telephone number dialed, telephone number dialing and message access-type function.

23. System according to any of the above claims, characterised in that the first button (13) is associated with a specific function while the second buttons (15) are associated with sub-functions of said specific function.
